(19) United States
(12) Patent Application Publication
(10) Pub. No.: US 2015/0298309 A1
(43) Pub. Date: Oct. 22, 2015

(54) Multi-Functional Power Tool

(71) Applicant: Irek Berdin, Thornhill (CA)

(72) Inventor: Irek Berdin, Thornhill (CA)

(21) Appl. No.: 14/689,830

(22) Filed: Apr. 17, 2015

Related U.S. Application Data
(60) Provisional application No. 61/981,400, filed on Apr. 18, 2014.

(51) Int. Cl. B25D 16/00

(52) U.S. Cl. CPC B25D 16/00

(57) ABSTRACT

The present invention discloses a multi-functional power tool. The multi-functional power tool includes an elongated shaft, a housing, a motor, a rotary impact mechanism, and an interchangeable tool deployment mechanism. The elongated shaft includes a top end and a bottom end. An ergonomic handle is attached to the top end of the elongated shaft. A housing is integrally attached to the bottom end of the elongated shaft. The housing includes a motor and a rotary impact mechanism adapted for providing rotary percussive motion. The interchangeable tool deployment mechanism has a tool receiving end that is operably connected to the rotary impact mechanism. The motor and impact mechanism provide rotary percussive motion to the tool receiving end of the interchangeable tool deployment mechanism.

### CROSS REFERENCE TO RELATED APPLICATION

This application claims the benefit of U.S. Provisional Application No. 61/981,400 filed on Apr. 18, 2014. The above identified patent application is herein incorporated by reference in its entirety to provide continuity of disclosure.

### FIELD OF THE INVENTION

The invention generally relates to a power tool. More particularly, the present invention relates to a multi-functional power tool having an interchangeable tool head, wherein a motor provides a rotary percussive motion to the interchangeable tool head via a rotary impact mechanism for removing ice, soil and other compacted materials.

### BACKGROUND OF THE INVENTION

Removing ice, particularly from paved surfaces, is quite important for many reasons, including public safety. Ice removal after an ice or snow storm is a difficult and time-consuming task. In areas affected by harsh winters, ice buildup on asphalt, concrete and metal surfaces is commonplace. Sidewalks, streets and driveways often become coated with thick layers of ice during winter months, and therefore must be frequently cleaned. Mechanical and chemical methods are commonly used to remove ice. Mechanical methods employ tools including snow shovels and ice chisels to break apart and remove the ice. Most consumers use hand ice scrappers to remove ice from a driveway. A problem with tools of this type is that they are not mechanized and are thus impractical for removing large amounts of ice. Such devices generally require considerable physical effort and may require the surface to be pre-treated with a chemical compound before the scraper works efficiently to remove the ice.

Chemical methods employ salts or other chemicals to soften or melt the ice. Chemical methods are not fully satisfactory because the chemicals may damage the surface from which the ice is to be removed and it takes several days and multiple treatments to melt the ice. Moreover, runoff carrying the chemicals may cause environmental degradation. Therefore, neither method is fully satisfactory.

Accordingly, an improved tool is needed that makes the most effective use possible of the force exerted by a user to remove the ice. It would also be advantageous to provide a tool for removing ice from a surface that breaks up and separates the ice sheet for more efficient cleaning without pretreating a surface.

### SUMMARY OF THE INVENTION

In view of the foregoing disadvantages inherent in the known types of ice removal tools now present in the prior art, the present invention provides a multi-functional power tool with an interchangeable head wherein the same can be utilized for providing convenience for the user when removing bulk ice from sidewalks, streets and driveways.

It is one aspect of the present invention to provide a multi-functional power tool with an interchangeable head. The multi-functional power tool includes an elongated shaft having a top end and a bottom end. A housing is integrally attached to the bottom end of the elongated shaft. The housing includes a motor adapted for transferring rotational motion to the rotary impact mechanism. An interchangeable tool deployment mechanism having a tool receiving end is operably connected to the motor. The rotary impact mechanism provides percussive motion to the tool receiving end of the interchangeable tool deployment mechanism.

According to another example embodiment of the present invention, the motor of the multi-functional power tool may further receive power from rechargeable battery unit. In another embodiment of the present invention, the motor of the multi-functional power tool may be powered by a remote power source (e.g., a household electrical outlet) through a power cord.

According to yet another embodiment of the present invention, the multi-functional power tool may further include an activation switch. The activation switch is configured to activate or deactivate the motor, adjust speed of the motor, or change the rotational direction of the motor.

In another embodiment of the present invention, the tool attached to the tool deployment mechanism may be an ice chopper, scraper, hoe, ice pick, chisel or spear.

In still yet another embodiment of the present invention, the multi-functional power tool may further include an illumination device at the bottom end of the housing, such as a light disposed on the bottom of the housing.

According to another embodiment of the present invention, the interchangeable tool deployment mechanism deploys the tool on the bottom end of the deployment mechanism and can be, but is not limited to designs such as a SDS type chuck, a hexagonal type chuck with a locking pin extending therethrough, or any other quick deployment mechanism.

According to yet another embodiment of the present invention, the multi-functional tool may comprise a motor that is electric or pneumatic.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an electrically operated multi-functional power tool according to one embodiment of the present invention.

FIG. 2 shows a perspective view of a gasoline operated multi-functional power tool according to one embodiment of the present invention.

FIGS. 3A-F show the interchangeable tool head attachments according to one embodiment of the present invention.

FIGS. 4A-B shows views of the chuck according to embodiments of the present invention.

### DETAILED DESCRIPTION OF THE INVENTION

Reference is made herein to the attached drawings. Like reference numerals are used throughout the drawings to depict like or similar elements of the multi-functional power tool. For the purposes of presenting a brief and clear description of the present invention, the preferred embodiment will be discussed as used for removing ice. The figures are intended for representative purposes only and should not be considered to be limiting in any respect.

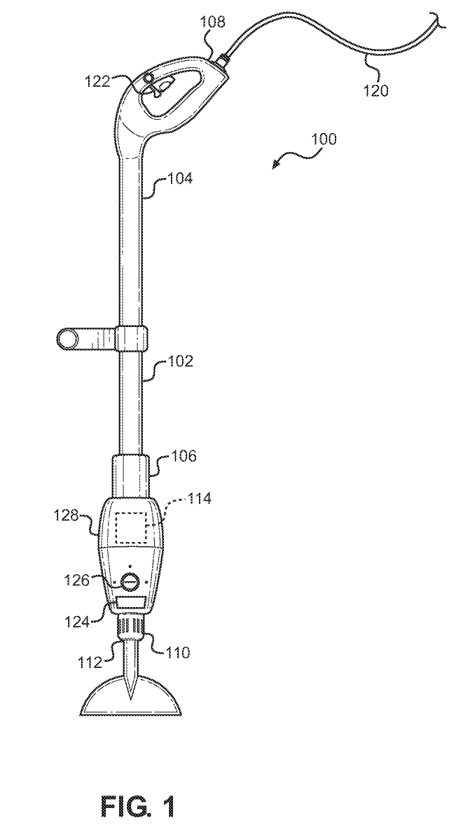

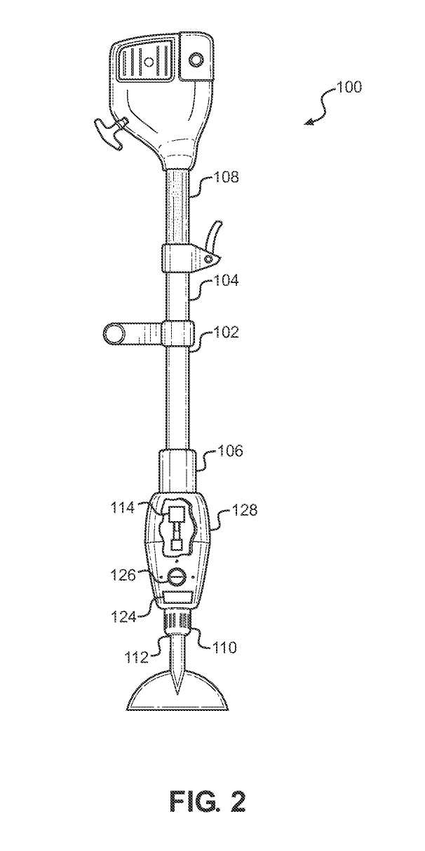

Referring now to FIGS. 1 and 2, there are shown perspective views of the electrically operated and gas operated multi-functional power tool 100, respectively. The multi-functional power tool 100 includes an elongated shaft 102 having a top end 104 and a bottom end 106. A handle 108 is permanently attached to the top end 104 of the elongated shaft 102. It is contemplated that the handle 108 for the invention has an ergonomic form and may be in the form of a pistol, T-type, or D-type grip. The elongated shaft 102 is linear and has a length suitable for use when a user is standing.

A housing 128 is integrally attached to the bottom end 106 of the elongated shaft 102. The housing 128 includes a motor 114 and rotary impact mechanism adapted for creating percussive motion. The housing 128 may include an illumination device 124 to allow the device to be effectively utilized in low light and nighttime conditions. The illumination device 124 can help users to illuminate their work area to enable precision and accuracy when targeting certain areas of the ground.

An interchangeable tool deployment mechanism 110 is operably connected to a rotary impact mechanism. The interchangeable tool deployment mechanism 110 includes a tool receiving end 112 adapted to receive and lock a tool therein. The motor 114 and rotary impact mechanism provide motion to the interchangeable tool deployment mechanism 110 causing movement of a tool. In one embodiment, a tool includes a shank having an SDS fitting, which is connectable to an SDS chuck of the interchangeable tool deployment mechanism 110. Tools having an SDS shank have the advantage that the SDS chuck has a spring-loaded locking mechanism, so that bits can be chucked with a simple and quick action. The SDS shank and chuck are particularly suited to hammer drilling in stone and concrete. The drill bit is not held solidly in the chuck, but can slide back and forth longitudinally, similar to the operation of a piston. In one embodiment, the multi-functional power tool 100 may further include a depth limiting adjustable pin mounted on the exterior of the housing 128. The depth limiting adjustable pin provides a limited range of motion for the tool to prevent damage to the treated surfaces.

A motor 114 is located within the housing 128 and is adapted to transfer rotational motion to the tool attached to the interchangeable tool deployment mechanism 110. Also, the motor 114 provides axial rotational motion to the impact mechanism. In turn, the impact mechanism transfers rotational motion from the motor to reciprocating motion of the piston. The piston is coupled to the rotatable shaft, wherein rotatable shaft drives the piston in a reciprocating motion. The reciprocating motion of the piston forcibly and repeatedly activate the striker and anvil which imparts axial impacts to the tool bit.

The multi-functional power tool may further include an activation switch 122. The activation switch 122 is coupled to the elongated shaft 102 or may be on the ergonomic handle 108. The activation switch 122 may be configured to activate or deactivate the motor 114. As is conventional for modern power tools, the activation switch 122 is provided with a forward/reverse switch which, on operation, facilitates reversal of the terminal connections between the power source and the motor thereby reversing the direction of rotation of the motor output as desired by the user. An activation switch is provided with built in speed regulator to adjust motor rotation speed for different applications.

The housing 128 may further include a mode selection actuator 126 which allows a user to select from at least three operating modes of the multi-functional power tool 100. The multi-functional power tool 100 can operate as a hammer, a rotary hammer, or a drill depending on the mode selected on the mode selection actuator. The different modes impart different movements to the interchangeable tool deployment mechanism 110. In this way, a single tool head can have multiple functions depending on the mode selected.

According to one embodiment of the present invention, a rechargeable battery unit may replace the gasoline operated system of the multi-functional power tool 100. For example, a lithium ion rechargeable battery may be provided. Traditional lithium ion rechargeable batteries have employed liquid electrolytes, such as a lithium-salt electrolyte (e.g., LiPF₆, LiBF₄, or LiCIO₄) mixed with an organic solvent (e.g., alkyl carbonate). As the battery is discharged to produce electrons, the electrolyte provides a medium for ion flow between the electrodes, and the electrons flow between the electrodes through an external circuit. In an alternate embodiment, the multi-functional power tool may further include a power cord 120 extending from the multi-functional power tool 100. The power cord, or cable, provides electrical power directly to the motor. The motor is preferably an electric motor, but may also be a pneumatic motor.

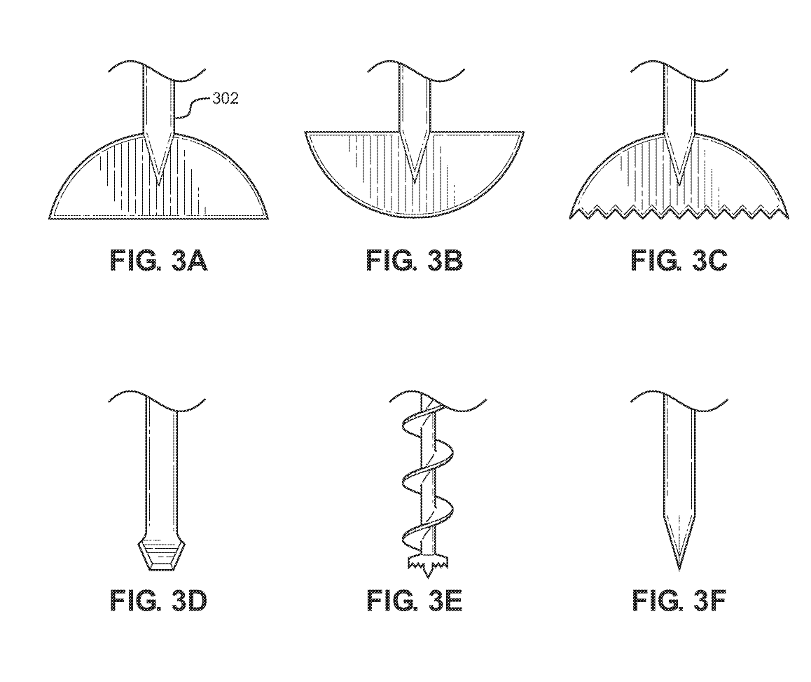

Referring now to FIG. 3A-F, there is shown interchangeable tool head attachments according to one embodiment of the present invention. A plurality of interchangeable tool head attachments are attachable to the elongated shaft via the interchangeable tool deployment mechanism to form a particular type of power tool having a dedicated function. Each of the tool head attachments have a necked section 302 for engagement with interchangeable tool deployment mechanism. The interchangeable tool deployment mechanism includes a tool receiving end 112 to receive each tool head attachment.

The interchangeable tool head attachments attached to the interchangeable tool deployment mechanism may be an ice chopper, scraper, hoe, ice pick, hammer, chisel or spear. The interchangeable tool is coupled for co-rotation with spindle and receiving axial hammering movement from the rotary impact mechanism described above. The tools rotate, reciprocate or rotate and reciprocate simultaneously according to the mode selected by a user via the mode selection actuator 126.

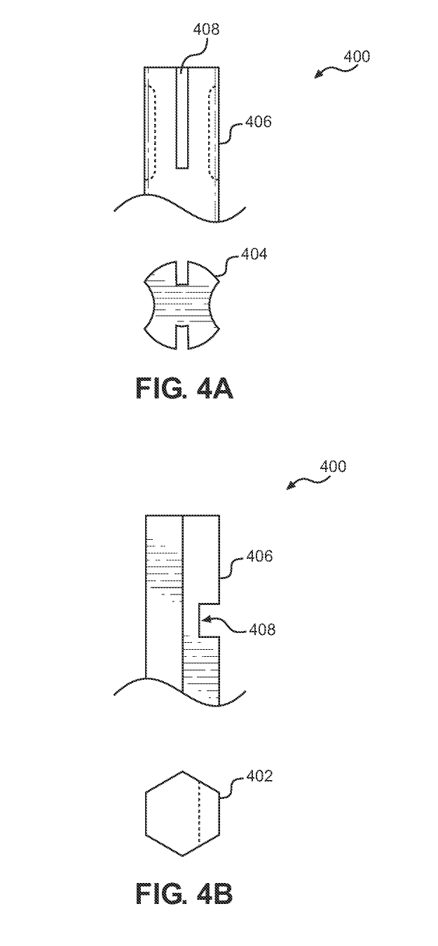

Referring now to FIG. 4A-B, there is shown views of the chuck 400 according to multiple embodiments of the present invention. The tool receiving end of the interchangeable tool deployment mechanism includes an SDS chuck 400 to receive a plurality of different interchangeable tools. The chucks can comprise multiple shapes such as a hexagonal shape 402 or another irregular shape 404. The interchangeable tools include a corresponding chuck member that mates with the chuck 400 of the multi-functional tool providing an attachment means. The SDS system uses an SDS shank 406 which is a cylindrical shank with indentations 408 to be held by the chuck. A tool is inserted into the chuck 400 by press fit, and is locked in place until a separate lock release is used. The rotary force is supplied through wedges that fit into two or three open grooves of the SDS chuck 400. The hammer action moves the tool bit up and down within the chuck since the bit is free to move a short distance. In one embodiment, two sprung balls fit into closed grooves, allowing movement while retaining the bit. SDS relies on a tool having the same shank diameter as the chuck.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multi-functional power tool, comprising:
an elongated shaft having a top end and a bottom end, wherein the top end includes an ergonomic handle;
a housing integrally attached to the bottom end of the elongated shaft, the housing including a motor and a rotary impact mechanism adapted to provide rotary percussive motion;
an interchangeable tool deployment mechanism operably connected to the motor and the impact mechanism within the housing;
wherein the interchangeable tool deployment mechanism includes a tool receiving end configured to receive a tool.

2. The multi-functional power tool of claim 1, wherein the tool receiving end includes an SDS chuck.

3. The multi-functional power tool of claim 1, wherein the tool receiving end includes a hexagonal chuck.

4. The multi-functional power tool of claim 1, further comprising a rechargeable battery unit coupled to the elongated shaft adapted to provide power for the motor.

5. The multi-functional power tool of claim 1, further comprising an activation switch, wherein the activation switch is configured to activate or deactivate the motor, change direction of motor rotation, and regulate speed of the motor.

6. The multi-functional power tool of claim 1, wherein the tool attached to the interchangeable tool deployment mechanism can be at least one of the following tools including an ice chopper, scraper, hoe, ice pick, hammer, chisel, and spear.

7. The multi-functional power tool of claim 1, further comprising an illumination device at the bottom end of the housing.

8. The multi-functional power tool of claim 1, wherein the motor provides axial rotational motion to a rotatable shaft and a piston.

9. The multi-functional power tool of claim 1, wherein the motor is an electric motor.

10. The multi-functional power tool of claim 1, wherein the motor is a pneumatic motor.

11. The multi-functional power tool of claim 1, further comprising a mode selection actuator on the housing configured to switch between a plurality of operating modes.

12. The multi-functional power tool of claim 1, wherein the motor and impact mechanism provides the rotary percussive motion to the tool receiving end of the interchangeable tool deployment mechanism.
